(19) United States
(12) Patent Application Publication
(10) Pub. No.: US 2024/0410768 A1
(43) Pub. Date: Dec. 12, 2024

(54) FORCE DETECTION DEVICE

(71) Applicant: Japan Display Inc., Tokyo (JP)

(72) Inventor: Kazuhiko SAKO, Tokyo (JP)

(21) Appl. No.: 18/674,068

(22) Filed: May 24, 2024

(30) Foreign Application Priority Data
Jun. 7, 2023 (JP) 2023-094102

(51) Int. Cl. G01L 1/20

(52) U.S. Cl. CPC G01L 1/205

(57) ABSTRACT

A force detection device includes a force sensor to which a load is applied. The force sensor includes a base, a first circuit formation layer, a sensor layer, and a second circuit formation layer stacked in order, the first circuit formation layer includes a first surface facing the sensor layer, a plurality of first detection electrodes disposed on the first surface, and a plurality of first individual detection regions divided corresponding to the first detection electrodes, and the second circuit formation layer includes a second surface facing the sensor layer, a detection surface facing opposite to the second surface and to which the load is applied, a plurality of second detection electrodes disposed on the second surface, and a plurality of second individual detection regions divided corresponding to the second detection electrodes.

### CROSS-REFERENCE TO RELATED APPLICATION

This application claims the benefit of priority from Japanese Patent Application No. 2023-094102 filed on Jun. 7, 2023, the entire contents of which are incorporated herein by reference.

### BACKGROUND

### 1. Technical Field

The present disclosure relates to a force detection device.

### 2. Description of the Related Art

Force detection devices include a force sensor to which force is applied and a drive controller that controls the drive of the force sensor. The force sensor described in Japanese Patent Application Laid-open Publication No. 2018-146489 includes a circuit formation layer provided with a plurality of inspection electrodes, a common electrode facing the detection electrodes, and a sensor layer sandwiched between the detection electrodes and the common electrode. In a state where no force is applied to the force sensor, the sensor layer is separated from the detection electrodes. When force is applied to the force sensor, the sensor layer moves toward and comes into contact with the detection electrodes. As a result, a current flows from the common electrode to the detection electrodes, whereby the application of force is detected. Thus, the force sensor can detect force in each of the detection electrodes. In other words, the detection region of the force sensor is divided into a plurality of individual detection regions the number of which is the same as that of the detection electrodes.

It has recently been desired to develop a force detection device in which the force detection area (individual detection region) is subdivided.

### SUMMARY

An object of the present disclosure is to provide a force detection device in which an area (region) for detecting force is subdivided.

A force detection device according to an embodiment of the present disclosure includes a force sensor to which a load is applied. The force sensor includes a base, a first circuit formation layer, a sensor layer, and a second circuit formation layer stacked in order. The first circuit formation layer includes a first surface facing the sensor layer, a plurality of first detection electrodes disposed on the first surface, and a plurality of first individual detection regions divided corresponding to the first detection electrodes, the second circuit formation layer includes a second surface facing the sensor layer, a detection surface facing opposite to the second surface and to which the load is applied, a plurality of second detection electrodes disposed on the second surface, and a plurality of second individual detection regions divided corresponding to the second detection electrodes, the first detection electrodes are arrayed in a first direction parallel to the detection surface and a second direction parallel to the detection surface and intersecting the first direction, the second detection electrodes are arrayed in the first direction and the second direction, the first detection electrodes and the second detection electrodes are displaced with respect to each other in the first direction and the second direction when viewed in a third direction intersecting the first direction and the second direction, one said second individual detection region is provided over a plurality of the first individual detection regions when viewed in the third direction, and a part of each first individual detection region and a part of each second individual detection region overlapping in the third direction are defined as a composite individual detection region, and the load is calculated for each of a plurality of the composite individual detection regions.

### BRIEF DESCRIPTION OF THE DRAWINGS

FIG. 1 is a perspective view schematically illustrating a force detection device according to an embodiment;

FIG. 2 is a schematic of a section of a force sensor; FIG. 3 is a circuit diagram of a circuit configuration of a first circuit formation layer according to the embodiment;

FIG. 4 is a schematic of a state where a load is applied to a detection surface of the force sensor according to the embodiment;

FIG. 5 is a block diagram of a configuration example of the force detection device according to the embodiment;

FIG. 6 is an enlarged schematic of extracted some of first detection regions and extracted some of second detection regions;

FIG. 7 is a diagram for explaining the force values detected in first individual detection regions and second individual detection regions and the calculated force values of composite individual detection regions; and

FIG. 8 is a timing chart of the operations of the force detection device according to the embodiment.

### DETAILED DESCRIPTION

Exemplary aspects (embodiments) to embody a force detection device according to the present disclosure are described below in greater detail with reference to the accompanying drawings. The contents described in the embodiments are not intended to limit the present disclosure. Components described below include components easily conceivable by those skilled in the art and components substantially identical therewith. Furthermore, the components described below may be appropriately combined. What is disclosed herein is given by way of example only, and appropriate modifications made without departing from the spirit of the present disclosure and easily conceivable by those skilled in the art naturally fall within the scope of the present disclosure. To simplify the explanation, the drawings may possibly illustrate the width, the thickness, the shape, and other elements of each unit more schematically than those in the actual aspect. These elements, however, are given by way of example only and are not intended to limit interpretation of the present disclosure. In the present specification and the drawings, components similar to those previously described with reference to previous drawings are denoted by like reference numerals, and detailed explanation thereof may be appropriately omitted.

To describe an aspect regarding a certain structure on which another structure is disposed in the present specification and the claims, when “on” is simply used, it indicates both the following cases unless otherwise noted: a case where the other structure is disposed directly on and in contact with the certain structure, and a case where the other structure is disposed on the certain structure with yet another structure interposed therebetween.

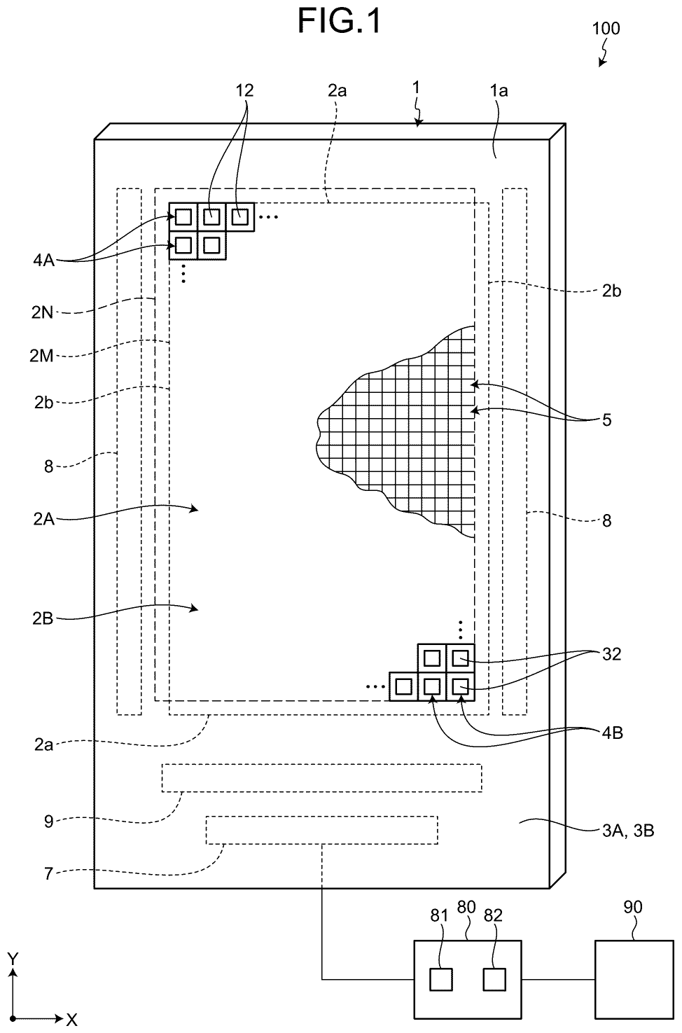

FIG. 1 is a perspective view schematically illustrating a force detection device according to an embodiment. As illustrated in FIG. 1, a force detection device 100 includes a force sensor 1 and a control substrate 80 that controls the operation (drive) of the force sensor 1. One surface of the force sensor 1 is a detection surface la for detecting force. The force sensor 1 is formed in a plate shape with a small thickness in the direction orthogonal to the detection surface la. The control substrate 80 is provided with a control circuit 81 and a power supply circuit 82. The control substrate 80 is coupled to a host 90. The host 90 is a host control device that controls the force detection device 100. The following describes each component.

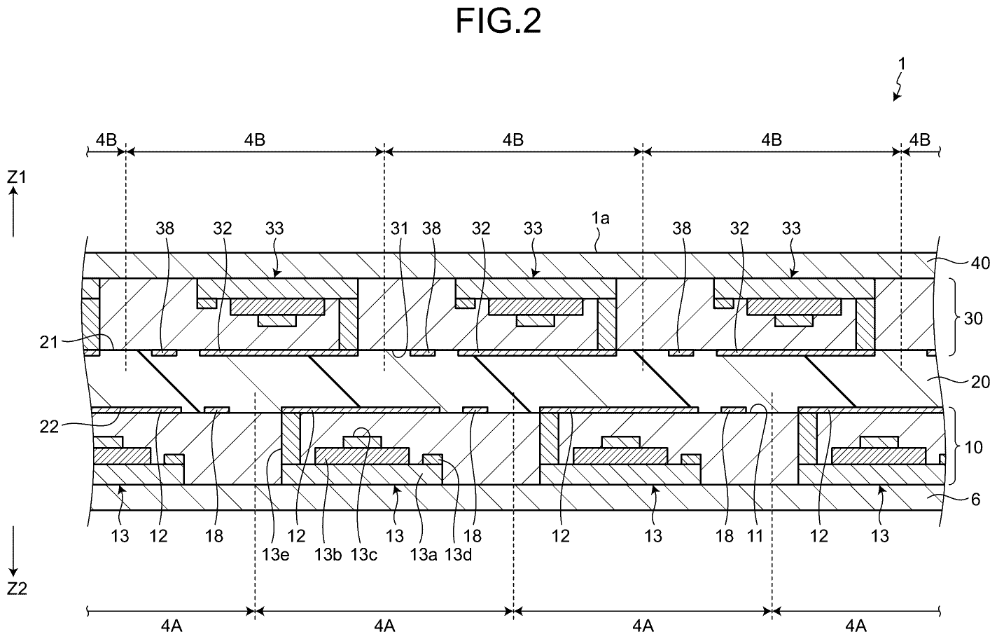

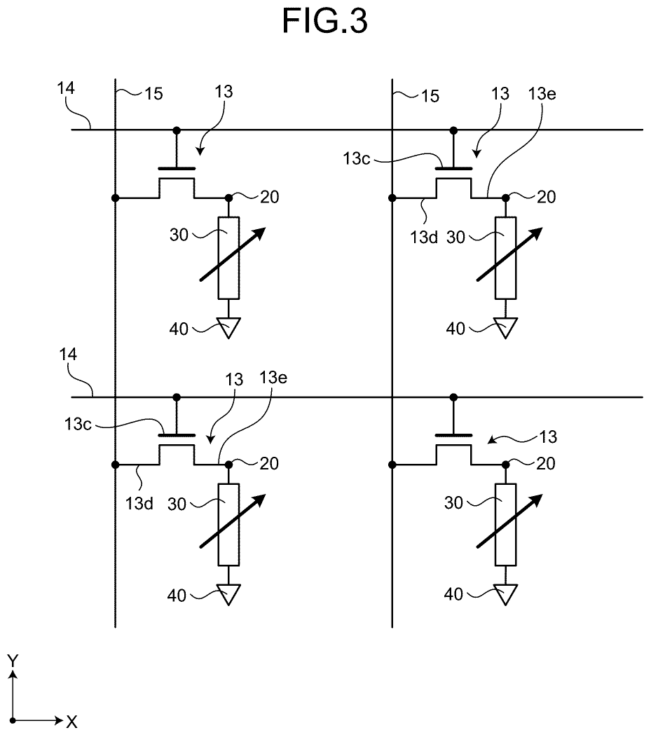

FIG. 2 is a schematic of a section of the force sensor. As illustrated in FIG. 2, the force sensor 1 includes a substrate 6, a first circuit formation layer 10, a sensor layer 20, a second circuit formation layer 30, and a protective layer 40 disposed in order. In the following description, the direction in which the substrate 6, the first circuit formation layer 10, the sensor layer 20, the second circuit formation layer 30, and the protective layer 40 are stacked is referred to as a stacking direction. The stacking direction may be referred to as a third direction. In the stacking direction, the direction in which the second circuit formation layer 30 is disposed when viewed from the first circuit formation layer 10 is referred to as a first stacking direction Z1. The direction opposite to the first stacking direction Z1 is referred to as a second stacking direction Z2. Viewing from the first stacking direction Z1 is referred to as plan view.

The substrate 6 is a base that supports the first circuit formation layer 10 and is made of material hard to deform when a load is applied thereto. The substrate 6 is an insulating substrate. The substrate 6 is a glass substrate or a resin substrate, for example.

The first circuit formation layer 10 is stacked on and integrated with the substrate 6. The first circuit formation layer 10 has a multilayered structure in which a plurality of insulating layers are stacked, which are not specifically illustrated. As illustrated in FIG. 1, the first circuit formation layer 10 is divided into a first detection region 2A for detecting force and a first peripheral region 3A not for detecting force in plan view. The first detection region 2A is positioned at the center of the first circuit formation layer 10. The first peripheral region 3A has a frame shape surrounding the outer periphery of the first detection region 2A.

The first detection region 2A is formed in a rectangular shape in plan view. An outer periphery 2M of the first detection region 2A has a pair of short sides 2a and a pair of long sides 2b. In the following description, the direction parallel to the detection surface la and parallel to the short side 2a is referred to as a first direction X. The direction parallel to the detection surface la and parallel to the long side 2b, that is, the direction orthogonal to (intersecting) the first direction X is referred to as a second direction Y. The stacking direction (third direction) described above is a direction orthogonal to (intersecting) the first direction X and the second direction Y.

As illustrated in FIG. 2, the first circuit formation layer 10 has a first surface 11 facing the first stacking direction Z1. The first surface 11 is provided with a plurality of first detection electrodes 12 and a plurality of first common electrodes 18.

The first detection electrode 12 is an electrode for detecting force and is made of metal material, such as indium tin oxide (ITO). As illustrated in FIG. 1, the first detection electrode 12 is formed in a rectangular shape in plan view. A plurality of first detection electrodes 12 are disposed in the first detection region 2A. The first detection electrodes 12 are arrayed in the first direction X and the second direction Y. Therefore, the first circuit formation layer 10 can detect force in each of the regions obtained by dividing the first detection region 2A in the first direction X and the second direction Y. The divided regions are referred to as first individual detection regions 4A. Thus, the first detection region 2A is composed of a plurality of first individual detection regions 4A arrayed in the first direction X and the second direction Y.

As illustrated in FIG. 2, a plurality of first drive transistors 13 are provided inside the first circuit formation layer 10. One first drive transistor 13 is provided to each of the first individual detection regions 4A. Therefore, the first drive transistors 13 are arrayed in the first direction X and the second direction Y corresponding to the respective first individual detection regions 4.

The first circuit formation layer 10 includes various components for driving the first drive transistors 13. Specifically, the first circuit formation layer 10 includes a first coupler 7 (refer to FIG. 1), a first gate line drive circuit 8 (refer to FIG. 1), a first signal line selection circuit 9 (refer to FIG. 1), first gate lines 14 (refer to FIG. 3), and first signal lines 15 (refer to FIG. 3).

As illustrated in FIG. 1, the first coupler 7, the first gate line drive circuit 8, and the first signal line selection circuit 9 are disposed in the first peripheral region 3A. The first coupler 7 is a component coupled to the control substrate 80 and is a flexible printed circuit board or a rigid circuit board, for example.

The first gate line drive circuit 8 is a circuit that drives a plurality of first gate lines 14 (refer to FIG. 3) based on various control signals supplied from the control circuit 81. The first gate line drive circuit 8 sequentially selects a plurality of first gate lines 14 and supplies gate drive signals to the selected first gate lines 14. The first signal line selection circuit 9 is a switch circuit that sequentially or simultaneously selects a plurality of first signal lines 15 (refer to FIG. 3). The first signal line selection circuit 9 is a multiplexer, for example. The first signal line selection circuit 9 couples the selected first signal lines 15 to the control circuit 81 based on selection signals supplied from the control circuit 81.

FIG. 3 is a circuit diagram of a circuit configuration of the first circuit formation layer according to the embodiment. As illustrated in FIG. 3, each first gate line 14 extends in the first direction X in the first detection region 2A. A plurality of first gate lines 14 are arrayed in the second direction Y. Each first signal line 15 extends in the second direction Y in the first detection region 2A. A plurality of first signal lines 15 are arrayed in the first direction X.

The first peripheral region 3A of the first circuit formation layer 10 is provided with first common wiring, which is not specifically illustrated. The first common wiring is wiring for supplying a current to the first common electrodes 18. The first common wiring is coupled to the control substrate 80 via the first coupler 7 and is supplied with a certain amount of current from the control circuit 81.

As illustrated in FIG. 2, the first drive transistor 13 includes a semiconductor layer 13a, a gate insulating film 13b, a gate electrode 13c, a drain electrode 13d, and a source electrode 13e. The source electrode 13e is coupled to the first detection electrode 12. The gate electrode 13c is coupled to the first gate line 14 (refer to FIG. 3). The drain electrode 13d is coupled to the first signal line 15 (refer to FIG. 3). When the first gate line 14 is scanned, the first drive transistor 13 is closed (turned on). As a result, an electrical signal (current) input to the first detection electrode 12 is output to the first signal line 15 via the first drive transistor 13. The electrical signal (current) is transmitted from the first signal line 15 to the control circuit 81.

One first common electrode 18 is provided to each of the first individual detection regions 4A. The first common electrode 18 is separated from the first detection electrode 12. The first common electrode 18 is coupled to the first common wiring (not illustrated) by wiring, which is not illustrated, buried in the second stacking direction Z2 with respect to the first surface 11 of the first circuit formation layer 10 and is supplied with a certain amount of current.

The sensor layer 20 is formed in a plate shape and extends in the first direction X and the second direction Y. The sensor layer 20 has a first sensor surface 21 facing the first stacking direction Z1 and a second sensor surface 22 facing the second stacking direction Z2. The second sensor surface 22 covers the first circuit formation layer 10 from the first stacking direction Z1 and is in contact with the first detection electrodes 12 and the first common electrodes 18.

The sensor layer 20 is made of material containing conductive fine particles in a highly insulating resin layer. The conductive fine particles are dispersed and separated from each other in the resin layer. As a result, the resistance of the sensor layer 20 is high when the resin layer is not deformed. Therefore, while the sensor layer 20 is in contact with each of the first detection electrodes 12 and the first common electrodes 18, the first detection electrode 12 and the first common electrode 18 are not electrically coupled. By contrast, when the resin layer is deformed, the fine particles come into contact with or in proximity to each other, and the resistance of the sensor layer 20 decreases. As the amount of deformation of the resin layer increases, the number of fine particles in contact with each other increases, and the resistance of the sensor layer 20 is significantly reduced. Therefore, when the sensor layer 20 is deformed, the first detection electrode 12 and the first common electrode 18 are electrically coupled.

Next, the second circuit formation layer 30 is described. The second circuit formation layer 30 has technical elements in common with the first circuit formation layer 10. Therefore, the common technical elements are simply explained in the description of the second circuit formation layer 30.

As illustrated in FIG. 1, the second circuit formation layer 30 is divided into a second detection region 2B for detecting force and a second peripheral region 3B not for detecting force in plan view. The second detection region 2B is positioned at the center of the second circuit formation layer 30.

The second detection region 2B has the same rectangular shape as that of the first detection region 2A and the same size as that of the first detection region 2A. The second detection region 2B is, however, slightly displaced with respect to the first detection region 2A in the first direction X and the second direction Y. In other words, the first detection region 2A and the second detection region 2B are shifted in the first direction X and the second direction Y. Thus, an outer periphery 2M of the first detection region 2A does not align with an outer periphery 2N of the second detection region 2B in plan view. The positional relation between the first detection region 2A and the second detection region 2B will be described later. The second peripheral region 3B has a frame shape surrounding the second detection region 2B.

As illustrated in FIG. 2, the second circuit formation layer 30 has a second surface 31 facing the second stacking direction Z2. The second surface 31 is provided with a plurality of second detection electrodes 32 and a plurality of second common electrodes 38. As illustrated in FIG. 1, the second detection electrode 32 is formed in a rectangular shape in plan view and has the same size as that of the first detection electrode 12. A plurality of second detection electrodes 32 are disposed in the second detection region 2B. The second detection electrodes 32 are arrayed in the first direction X and the second direction Y. Thus, the second detection region 2B is composed of a plurality of second individual detection regions 4B arrayed in the first direction X and the second direction Y.

As illustrated in FIG. 2, a plurality of second drive transistors 33 are provided inside the second circuit formation layer 30. One second drive transistor 33 is provided to each of the second individual detection regions 4B. The second circuit formation layer 30 includes a second coupler, a second gate line drive circuit, a second signal line selection circuit, second gate lines, and second signal lines for driving the second drive transistors 33, which are not specifically illustrated.

One second common electrode 38 is provided to each of the second individual detection regions 4B. The second common electrode 38 is separated from the second detection electrode 32. The second common electrode 38 is coupled to second common wiring (not illustrated) by wiring, which is not illustrated, buried in the second circuit formation layer 30. The second common wiring is provided in the second peripheral region 3B of the second circuit formation layer 30. The second common wiring is coupled to the control substrate 80 via the second coupler and is supplied with a certain amount of current from the control circuit 81. Therefore, the second common electrode 38 is supplied with a certain amount of current. The first sensor surface 21 of the sensor layer 20 covers the second circuit formation layer 30 from the second stacking direction Z2 and is in contact with the second detection electrodes 32 and the second common electrodes 38.

The protective layer 40 is made of elastically deformable insulating material, such as rubber and resin. The surface of the protective layer 40 facing the first stacking direction Z1 serves as the detection surface la. The protective layer 40 is not necessarily required in the present disclosure. In other words, the surface of the second circuit formation layer 30 facing the first stacking direction Z1 may serve as the detection surface la.

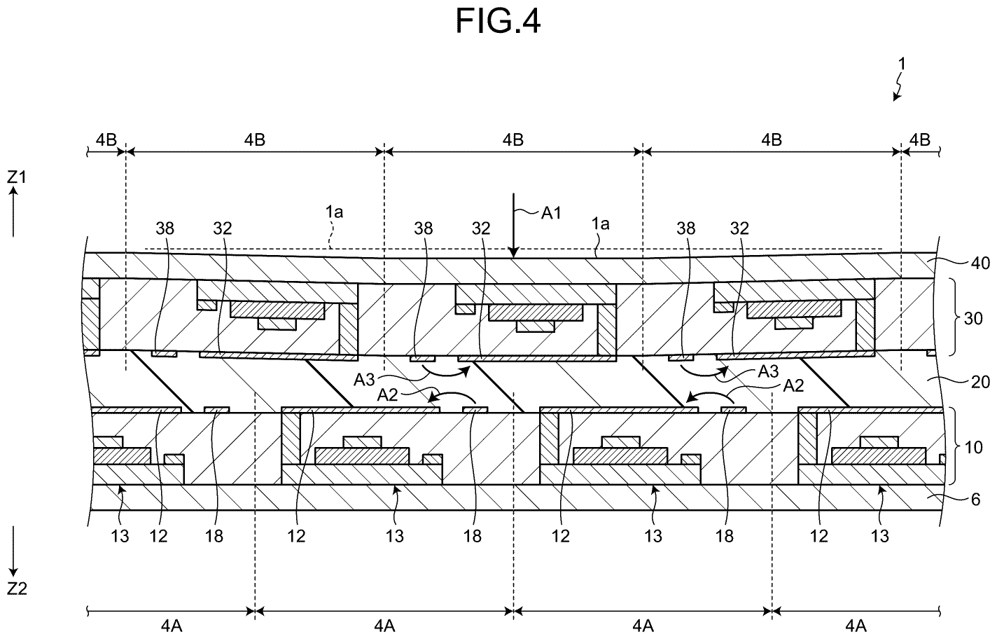

FIG. 4 is a schematic of a state where a load is applied to the detection surface of the force sensor according to the embodiment. The dashed line 1a illustrated in FIG. 4 indicates the position of the detection surface la before force is applied. The following describes a case where a load is applied to the force sensor 1. As illustrated in FIG. 4, when force (load in the second stacking direction Z2, refer to arrow Al in FIG. 4) is applied to the detection surface la, the load is transmitted to the sensor layer 20 via the protective layer 40 and the second circuit formation layer 30. The first sensor surface 21 of the sensor layer 20 is depressed in the second stacking direction Z2, and the thickness of the sensor layer 20 in the stacking direction decreases.

As a result, the resistance of the sensor layer 20 decreases, and the first detection electrode 12 and the first common electrode 18 are electrically coupled. A current flows from the first common electrode 18 to the first detection electrode 12 (refer to arrow A2). The current flowing to the first detection electrode 12 is transmitted to the control circuit 81 via the first signal line 15. The second detection electrode 32 and the second common electrode 38 are also electrically coupled, and a current flows from the second common electrode 38 to the second detection electrode 32 (refer to arrow A3). The current flowing to the second detection electrode 32 is transmitted to the control circuit 81 via the second signal line (not illustrated).

As described above, when force is applied to the detection surface la, force is detected in each of the first circuit formation layer 10 and the second circuit formation layer 30. As the force (refer to arrow A1) increases, the amount of deformation of the sensor layer 20 increases, and the amount of reduction in the resistance of the sensor layer 20 increases. Therefore, the magnitude of the applied force can be detected by measuring the value of the current flowing to the first detection electrodes 12 and the second detection electrodes 32.

As illustrated in FIG. 1, the control circuit 81 provided to the control substrate 80 is a control integrated circuit (control IC). The power supply circuit 82 supplies electric power to the control circuit 81. As a result, the control circuit 81 can generate signals to be supplied to the force sensor 1.

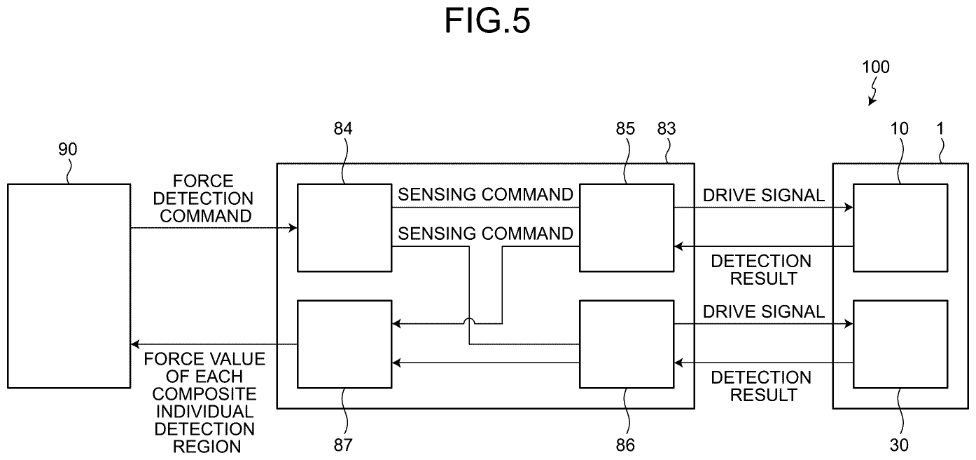

FIG. 5 is a block diagram of a configuration example of the force detection device according to the embodiment. The control circuit 81 and the power supply circuit 82 constitute a drive controller 83. The drive controller 83 includes a timing controller 84, a first drive controller 85, a second drive controller 86, and a data synthesizer 87.

The timing controller 84 receives a force detection command from the host 90 and commands the first drive controller 85 and the second drive controller 86 to perform sensing. The timing controller 84 deviates the timing of the sensing command to the first drive controller 85 from the timing of the sensing command to the second drive controller 86.

When receiving the sensing command, the first drive controller 85 supplies drive signals to the first gate line drive circuit 8 and the first signal line selection circuit 9. As a result, the first circuit formation layer 10 detects the force applied to the first individual detection regions 4A. The first drive controller 85 receives the results of detection (force values (current values) of the respective individual detection regions 4A) by the first circuit formation layer 10 and transmits them to the data synthesizer 87.

When receiving the sensing command, the second drive controller 86 supplies drive signals to the second gate drive circuit (not illustrated) and the second signal line selection circuit (not illustrated). As a result, the second circuit formation layer 30 detects the force applied to the second individual detection regions 4B. The second drive controller 86 receives the results of detection (force values (current values) of the respective second individual detection regions 4B) by the second circuit formation layer 30 and transmits them to the data synthesizer 87.

The data synthesizer 87 synthesizes the force values of the first individual detection regions 4A and the force values of the second individual detection regions 4B. The method of synthesis by the data synthesizer 87 will be described later. The data synthesizer 87 supplies the synthesis results to the host 90. The synthesis results are the force values of respective composite individual detection regions 5, which will be described later.

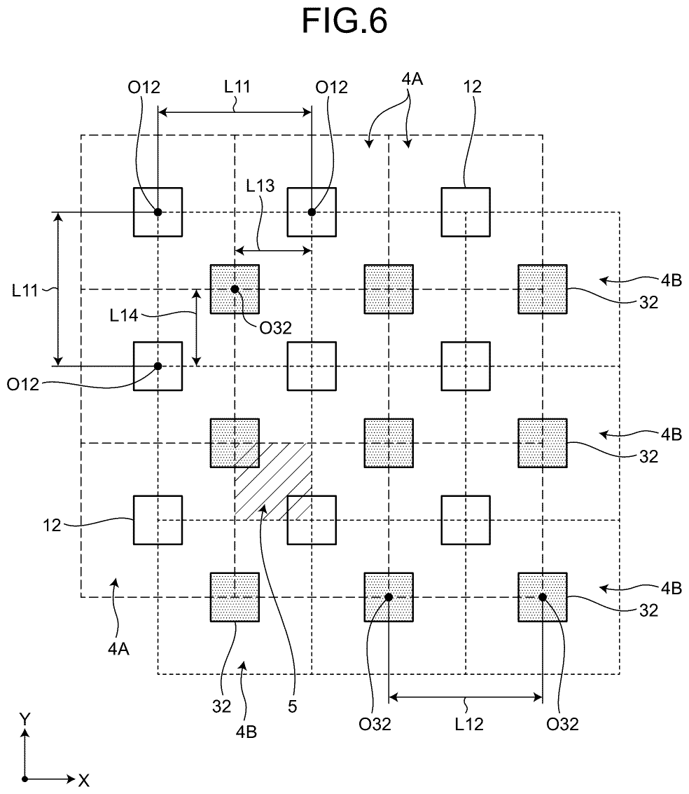

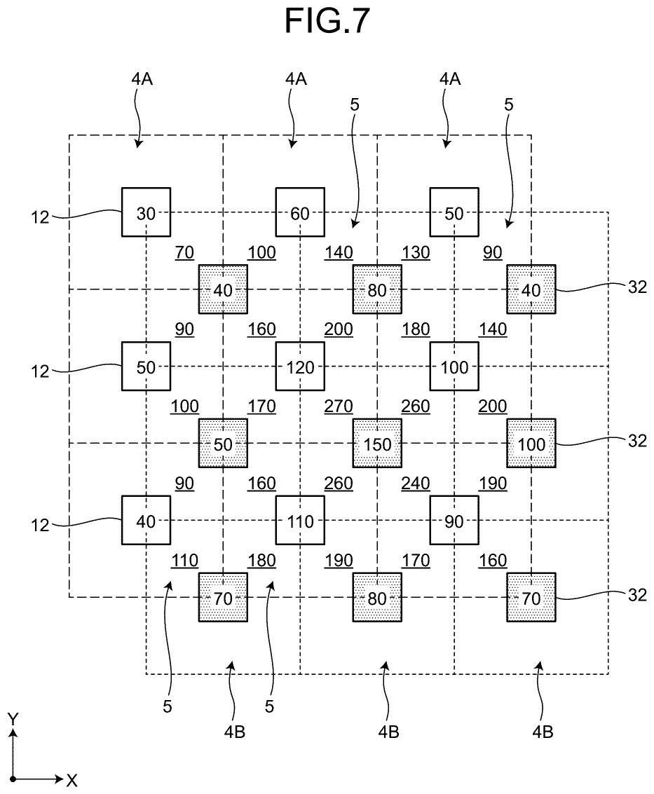

The following describes the positional relation between the first detection region 2A and the second detection region 2B in greater detail. FIG. 6 is an enlarged schematic of extracted some of the first detection regions and extracted some of the second detection regions. In FIGS. 6 and 7, the second detection electrodes 32 are shaded with dots to facilitate distinguishing between the first detection electrodes 12 and the second detection electrodes 32. As illustrated in FIG. 6, the first detection electrodes 12 and the second detection electrodes 32 are displaced with respect to each other in the first direction X and the second direction Y in plan view.

More specifically, a distance between centers O12 of the first detection electrodes 12 adjacent to each other in the first direction X and the second direction Y is L11. A distance L12 between centers O32 of the second detection electrodes 32 is equal to the distance L11. A distance L13 between the center O12 and the center O32 in the first direction X is half of the distance L11. Thus, the second detection electrode 32 is disposed in the middle of two first detection electrodes 12 adjacent to each other in the first direction X. A distance L14 between the center O12 and the center O32 in the second direction Y is half of the distance L11, which is equal to the distance L13. Thus, the second detection electrode 32 is disposed in the middle of two first detection electrodes 12 adjacent to each other in the second direction Y.

One second individual detection region 4B overlaps four (a plurality of) first individual detection regions 4A in plan view. In other words, one-quarter part of the first individual detection region 4A and one-quarter part of the second individual detection region 4B overlap each other. In the following description, the region where one-quarter part of the first individual detection region 4A and one-quarter part of the second individual detection region 4B overlap each other is referred to as the composite individual detection region 5 (refer to the hatched region in FIG. 6).

As described above, the first detection region 2A and the second detection region 2B are displaced with respect to each other in the first direction X and the second direction Y by one composite individual detection region 5. The following describes an example of the method of synthesis (method of calculating the force value of the composite individual detection region 5) by the data synthesizer 87.

FIG. 7 is a diagram for explaining the force values detected in the first individual detection regions and the second individual detection regions and the calculated force values of the composite individual detection regions. The values illustrated in FIG. 7 are force values. The force values in the composite individual detection regions 5 are underlined. The data synthesizer 87 according to the embodiment calculates the force value detected in the composite individual detection region 5 by adding up the force values respectively detected in the first individual detection region 4A and the second individual detection region 4B overlapping the composite individual detection region 5.

For example, let us assume that the force value detected in the first individual detection region 4A is “30” (refer to the first individual detection region 4A positioned at the upper left in FIG. 7). Let us assume that the force value detected in the second individual detection region 4B is “40” (refer to the second individual detection region 4B positioned at the upper left in FIG. 7). In this case, the data synthesizer 87 adds up the force value “30” and the force value “40” to calculate a value “70” as the force value detected in the composite individual detection region 5. The force values of the composite individual detection regions 5 are calculated by the method described above.

The timing controller 84 according to the present embodiment deviates the timing of the sensing command to the first drive controller 85 from the timing of the sensing command to the second drive controller 86. Next, the advantageous effects of this configuration are explained.

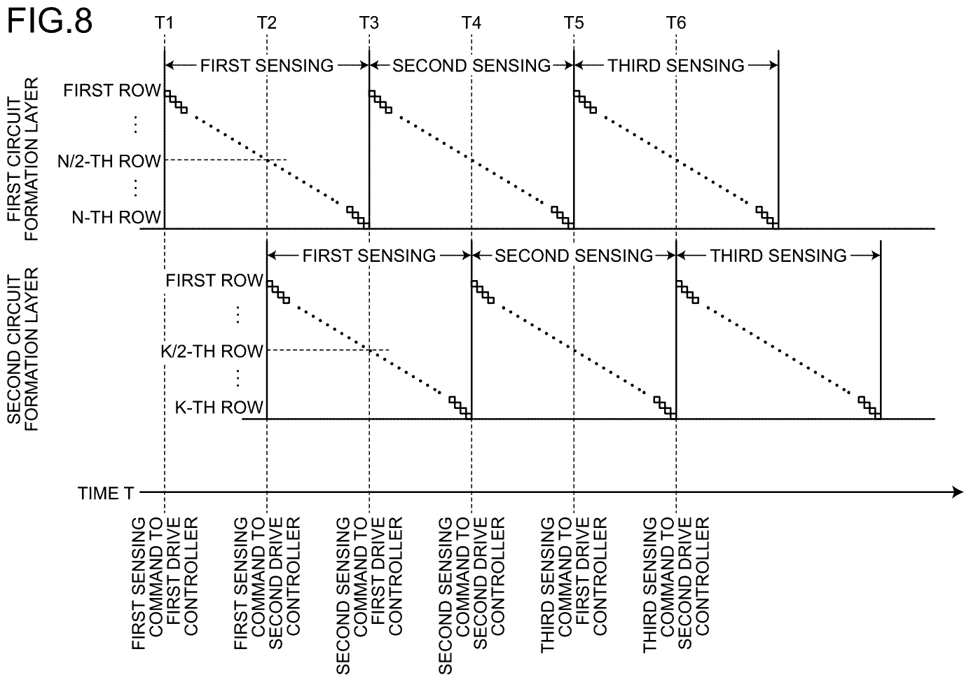

FIG. 8 is a timing chart of the operations of the force detection device according to the embodiment. The first circuit formation layer 10 according to the present embodiment is assumed to include N first gate lines 14 arrayed in the second direction Y. The second circuit formation layer 30 is assumed to include K second gate lines (not illustrated) arrayed in the second direction Y. The number N of first gate lines 14 and the number K of second gate lines are equal (N=K).

In sensing, the first gate line drive circuit 8 of the first circuit formation layer 10 selects the first gate lines 14 in order from the first gate line 14 of the first row disposed at one end in the second direction Y to the first gate line 14 of the N-th row disposed at the other end in the second direction Y. Similarly, the second gate line drive circuit (not illustrated) of the second circuit formation layer 30 selects the second gate lines (not illustrated) in order from the second gate line (not illustrated) of the first row disposed at one end in the second direction Y to the second gate line (not illustrated) of the K-th row disposed at the other end in the second direction Y.

As illustrated in FIG. 8, the time T when the timing controller 84 gives the sensing command to the first drive controller 85 is time T1, time T3, and time T5. By contrast, the time T when the timing controller 84 gives the sensing command to the second drive controller 86 is time T2, time T4, and time T6, and these times T are staggered.

This is an example of the timing controller 84 according to the present embodiment giving a total of three sensing commands of a first sensing command, a second sensing command, and a third sensing command to the first drive controller 85 and the second drive controller 86. With this configuration, changes over time in force can be detected. The present disclosure, however, does not necessarily perform sensing a plurality of times.

The first sensing command to the second drive controller 86 is given at time T2. Time T2 is the time when half of the time required for the first sensing by the first circuit formation layer 10 has elapsed. In other words, at time T2, the second circuit formation layer 30 is scanning the second gate line (not illustrated) of the first row, while the first circuit formation layer 10 is scanning the first gate line 14 of the N/2-th row. Therefore, the scanning points in the first circuit formation layer 10 and the second circuit formation layer 30 are different in the second direction Y.

Similarly, at time T3, the first circuit formation layer 10 is scanning the first gate line 14 of the first row by the second sensing command, while the second circuit formation layer 30 is scanning the second gate line (not illustrated) of the K/2-th row. Therefore, the scanning points in the first circuit formation layer 10 and the second circuit formation layer 30 are different in the second direction Y.

This configuration can prevent a current from flowing from the first common electrode 18 of the first circuit formation layer 10 to the second detection electrode 32 of the second circuit formation layer 30 or from the second common electrode 38 of the second circuit formation layer 30 to the first detection electrode 12 of the first circuit formation layer 10. In other words, the reliability of the sensing results is improved.

As described above, the embodiment enables calculating the value of force acting on each of the composite individual detection regions 5. The size of the composite individual detection region 5 is a quarter of the conventional individual detection region (the first individual detection region and the second individual detection region). Therefore, the force detection device 100 according to the embodiment enables subdividing the area (region) for detecting force. While the number of detection electrodes and the number of detection areas (individual detection regions) according to the conventional technology are equal, the number of composite individual detection regions 5 according to the present embodiment is larger than that of detection electrodes (the first detection electrodes 12 and the second detection electrodes 32). Therefore, the number of detection electrodes can be reduced.

In the force sensor 1 according to the embodiment, one sensor layer 20 is shared by the first circuit formation layer 10 and the second circuit formation layer 30. Therefore, a current may possibly flow from the first common electrode 18 of the first circuit formation layer 10 to the second detection electrode 32 of the second circuit formation layer 30 or from the second common electrode 38 of the second circuit formation layer 30 to the first detection electrode 12 of the first circuit formation layer 10. In the present embodiment, however, the timing of the sensing command to the first circuit formation layer 10 is deviated from that of the sensing command to the second circuit formation layer 30. Therefore, a current does not flow from the first common electrode 18 of the first circuit formation layer 10 to the second detection electrode 32 of the second circuit formation layer 30 or from the second common electrode 38 of the second circuit formation layer 30 to the first detection electrode 12 of the first circuit formation layer 10.

While the force detection device 100 according to the embodiment has been described above, the present disclosure is not limited to the example described in the embodiment. For example, while the data synthesizer 87 according to the embodiment calculates the force value of the composite individual detection region 5 simply by adding up the force value detected in the first individual detection region 4A and the force value detected in the second individual detection region 4B, the present disclosure is not limited to this synthesis method. The present disclosure may calculate the average of the force value detected in the first individual detection region 4A and the force value detected in the second individual detection region 4B as the composite individual detection region 5. While the sensing command to the second circuit formation layer 30 according to the present embodiment is given after half of the time required for the first sensing by the first circuit formation layer 10 has elapsed (time T2, T4, and T6), the present disclosure is not limited thereto.

If the distance between the first common electrode 18 and the second detection electrode 32 or the distance between the second common electrode 38 and the first detection electrode 12 is relatively large, that is, if a current is less likely to flow from the first common electrode 18 to the second detection electrode 32 or from the second common electrode 38 to the first detection electrode 12, the sensing by the first circuit formation layer 10 and the sensing by the second circuit formation layer 30 may be performed simultaneously. While the detection regions of the first circuit formation layer 10 and the second circuit formation layer 30 according to the embodiment above have substantially the same size, one of the detection regions may be smaller than the other. More specifically, the first detection region 2A formed by the first circuit formation layer 10 may be formed slightly smaller than the second detection region 2B formed by the second circuit formation layer 30, and the first detection region 2A may be included in the second detection region 2B in plan view. In this case, the detection electrodes in both circuit formation layers have the same size, and the numbers of gate lines, signal lines, and detection electrodes in the first circuit formation layer 10 are smaller than those in the second circuit formation layer 30. The size of the first detection region 2A may be made different from that of the second detection region 2B by decreasing or increasing only the number of gate lines or signal lines of the first circuit formation layer 10 compared with that of the second circuit formation layer 30.

While the sensor layer 20 according to the embodiment is made of material containing conductive fine particles in a resin layer, the present disclosure is not limited thereto. For example, the sensor layer may be made of conductive resin, and the detection electrode and the common electrode may be electrically coupled by increasing the contact area between the detection electrode and the common electrode.

While the second detection electrode 32 according to the embodiment is disposed in the middle of the first detection electrodes 12, the second detection electrode 32 according to the present disclosure may be displaced with respect to the middle of the first detection electrodes 12.

What is claimed is:

1. A force detection device comprising:
a force sensor to which a load is applied, wherein
the force sensor includes a base, a first circuit formation layer, a sensor layer, and a second circuit formation layer stacked in order,
the first circuit formation layer includes:
a first surface facing the sensor layer;
a plurality of first detection electrodes disposed on the first surface; and
a plurality of first individual detection regions divided corresponding to the first detection electrodes,
the second circuit formation layer includes:
a second surface facing the sensor layer;
a detection surface to which the load is applied, the second surface being disposed between the detection surface and the sensor layer;
a plurality of second detection electrodes disposed on the second surface; and
a plurality of second individual detection regions divided corresponding to the second detection electrodes,
the first detection electrodes are arrayed in a first direction parallel to the detection surface and a second direction parallel to the detection surface and intersecting the first direction,
the second detection electrodes are arrayed in the first direction and the second direction,
the first detection electrodes and the second detection electrodes are shifted in the first direction and the second direction when viewed in a third direction intersecting the first direction and the second direction,
one of the second individual detection regions is provided over the first individual detection regions when viewed in the third direction,
composite individual detection regions are provided above the base,
each of the composite individual detection regions is a region where a part of a corresponding one of the first individual detection regions overlaps a part of a corresponding one of the second individual detection regions in a plan view, and
the load is calculated for each of the composite individual detection regions.

2. The force detection device according to claim 1, wherein the second detection electrodes are each disposed in a middle of two of the first detection electrodes adjacent to each other in the first direction and in a middle of two of the first detection electrodes adjacent to each other in the second direction.

3. The force detection device according to claim 1, further comprising a drive controller configured to control drive of each of the first circuit formation layer and the second circuit formation layer, wherein
the drive controller calculates a force value of each of the composite individual detection regions from force values detected from the corresponding one of the first individual detection regions and the corresponding one of the second individual detection regions.

4. The force detection device according to claim 2, further comprising a drive controller configured to control drive of each of the first circuit formation layer and the second circuit formation layer, wherein
the drive controller calculates a force value of each of the composite individual detection regions from force values detected from the corresponding one of the first individual detection regions and the corresponding one of the second individual detection regions.

5. The force detection device according to claim 3, wherein the drive controller deviates a timing of detecting force acting on the first circuit formation layer from a timing of detecting force acting on the second circuit formation layer.

6. The force detection device according to claim 4, wherein the drive controller deviates a timing of detecting force acting on the first circuit formation layer from a timing of detecting force acting on the second circuit formation layer.

7. The force detection device according to claim 1, wherein a first period of detecting force acting on the first circuit formation layer is different from a second period of detecting force acting on the second circuit formation layer.

8. The force detection device according to claim 7, wherein a first start timing of the first period is different from a second start timing of the second period.

9. The force detection device according to claim 8, wherein a first time length of the first period is a same as a second time length of the second period.

10. The force detection device according to claim 1, wherein force acting on the first circuit formation layer is detected in a first period,
force acting on the second circuit formation layer is detected in a second period, and
a part of the first period overlaps the second period.

11. The force detection device according to claim 1, wherein force acting on the first circuit formation layer is detected in a first period,
force acting on the second circuit formation layer is detected in a second period and a third period,
a first part of the first period overlaps the second period, and
a second part of the first period overlaps the third period.

12. The force detection device according to claim 11, wherein the third period is next to the second period.

13. The force detection device according to claim 11, wherein the second part is all a rest of the first part during the first period.

14. The force detection device according to claim 11, wherein force acting on the first circuit formation layer is detected in a fourth period which is different from the first period,
a third part of the second period overlaps the first period, and
a fourth part of the second period overlaps the fourth period.

15. The force detection device according to claim 14, wherein the third period is next to the second period, and
the fourth period is next to the first period.

16. The force detection device according to claim 14, wherein the second part is all a rest of the first part during the first period, and
the fourth part is all a rest of the third part during the second period.

17. The force detection device according to claim 1, wherein force acting on the first circuit formation layer is detected in a first period and a fourth period,
force acting on the second circuit formation layer is detected in a second period,
a first part of the second period overlaps the first period, and
a second part of the second period overlaps the fourth period.

18. The force detection device according to claim 17, wherein the fourth period is next to the first period.

19. The force detection device according to claim 17, wherein the second part is all a rest of the first part during the second period.
